(19) United States
(12) Patent Application Publication
(10) Pub. No.: US 2005/0125079 A1
(43) Pub. Date: Jun. 9, 2005

(54) Interactive instructions in sequential control modules in controllers

(76) Inventors: James M. Schreder, Denver, PA (US); James A. Strilich, Phoenix, AZ (US); Thomas C. Marks, Harleysville, PA (US); Peter Hartmann, Fort Washington, PA (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/729,774

(22) Filed: Dec. 8, 2003

(51) Int. Cl. G05B 15/00

(52) U.S. Cl. 700/1

(57) ABSTRACT

Interactive instructions in sequential control modules in controllers supports the integration of manual operations with automated process actions in the sequential control module function block, which executes in various controller platforms. Also supported is a table view operator display for effective interaction with the manual instructions. Manual interactions and changes are journaled so that a record of all actions is recorded.

### BACKGROUND OF THE INVENTION

1. Field of the Invention

The present disclosure generally relates to automated process control. In particular, the present disclosure relates to interactive instructions, sequential control modules, controllers, integration of manual operations with automated process actions, operator displays, and other applications and features.

2. Discussion of the Background Art

Conventional automated process control systems are used in industrial plants and mills to integrate, control and monitor complex processes in many types of industrial settings, including refineries, pharmaceuticals, power and chemical plants, and pulp, paper and printing mills.

U.S. Pat. No. 6,317,638 B1 to Schreder et al. and entitled “Multi-Layer State Machine for a Hybrid Real-Time Control System and Method of Operation Thereof” describes a system architecture for use with a state machine capable of controlling a real-time process and having a plurality of states and handlers that govern transitions between ones of the plurality of states. This describes basic sequential control module (SCM) functionality, which is fully automatic and performs without any operator invention. There is a need to extend and enhance the functionality of SCMs to provide interactions with an operator.

There is a need for consistent management, implementation, and execution of procedural operations and transitions in industrial plants. By doing so, a plant would be able to ensure compliance with current local standard operating procedures and practices and would be able to improve quality and operational consistency through the use of best operator practices. Addressing this need would improve process productivity by optimizing operator resources, providing efficient guidelines for presentation and planning of actions, and reducing activity and transition tines. The solution would be capable of integrating manual operations with automated process actions, following applicable industry standards based on physical and procedural models. As well, the solution would restrict access to all manual interactions and provide an audit trail of all actions, security or signoff access restrictions, and qualification verification.

### SUMMARY OF THE INVENTION

The present invention has many aspects and is generally directed to interactive instructions in sequential control modules in controllers that fulfills the above needs and more.

One aspect is a method of providing interactive instructions in sequential control modules. It is determined whether a current instruction in a sequential control module is of a confirmable type. If the current instruction is the confirmable type, then it is determined whether the current instruction is confirmed by an operator. If the current instruction is confirmed by the operator and it is the confirmable type, then the current output is marked as complete. In some embodiments, it is determined whether the current instruction is an information type. If the current instruction is the information type, then the current output is marked as complete. In some embodiments, it is determined whether the current output is an automatic type. If the current output is the automatic type, the current expression is executed and its value is stored to a destination reference.

Another aspect is a system for providing interactive instructions in sequential control modules, including a user interface component, an operator station, and at least one controller. The user interface component provides a table view. The operator station is capable of executing the user interface component. The controller is capable of being operated by executing at least one interactive instruction from the table view. The interactive instruction is part of a sequential control module.

In some embodiments, the controller is capable of being operated by executing at least one non-interactive instruction from the table view and the non-interactive instruction is part of the sequential control module. In some embodiments, the system also includes a journaling component. The journaling component is capable of being executed on the processor for recording information related to the execution of the sequential control module. In some embodiments, the table view includes a summary area, a details area, and a parameters area. The summary area provides the name of the sequential control module and a list of the steps in the sequential control module. The details area provides the step name and the step description for the selected step in the list of steps. The parameters area provides the current value of at least one parameter associated with the selected step.

In some embodiments, the table view also includes an additional details area for information associated with the selected step. In some embodiments, the table view also includes a trend area for providing a graph of the parameters associated with the selected step. In some embodiments, the details area includes a confirmation component to receive a confirmation from an operator. In some embodiments, the user interface component also provides a sequential function chart view.

Another aspect is a computer readable medium, (i.e., a CD, a floppy disk, a website, or the like) having executable instructions stored thereon to perform a method of providing interactive instructions in sequential control modules. A type indication is provided on a display for an instruction in a sequential control module. The type is either confirmable or informational. A confirmation from an operator is received before completing the instruction, if the type is confirmable. In some embodiments, at least one value of a parameter associated with the instruction is provided on the display. In some embodiments, additional information about the current instruction is provided on the display.

### BRIEF DESCRIPTION OF THE DRAWINGS

These and other features, aspects, and advantages of the present disclosure will become better understood with reference to the following description, appended claims, and drawings where:

FIG. 1 is a screenshot of an example operator display;

FIG. 2 is a block diagram of an example sequential function chart (SFC) view of an sequential control module (SCM) configuration;

FIG. 3 is a screenshot of an example step having a confirmable instruction that is collapsed;

FIG. 4 is a screenshot of an example step having the confirmable instruction that is expanded;

FIG. 5 is a screenshot of an example step with one of two confirmable instructions confirmed;

FIG. 6 is a screenshot of an alarm and step output failure indication;

FIG. 7 is a flowchart showing an example method of step output execution supporting both automatic expressions and interactive instructions; and

FIG. 8 is a block diagram of an example system architecture.

### DETAILED DESCRIPTION OF THE PREFERRED EMBODIMENT

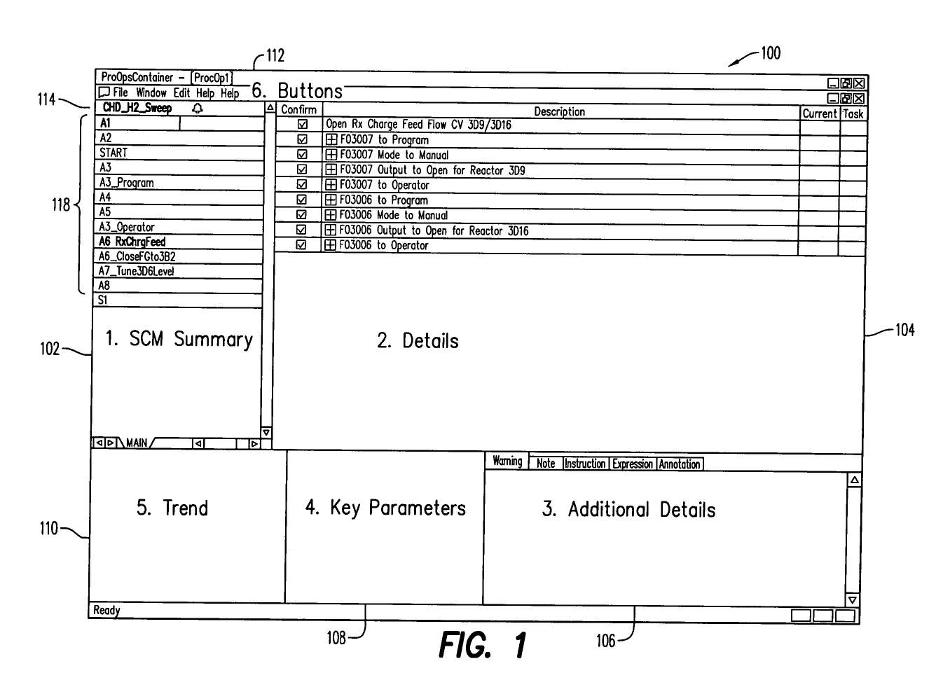

FIG. 1 shows an example operator display. An operator uses the display to execute interactive procedures for an automated process control application. Sequential control modules (SCMs) automate some procedures that previously were executed using paper documents. SCM steps support note and warning information and associated current value and monitoring task status. SCM step outputs include instruction information that is presented to the operator to explain an action that is to be done. A step has a number of outputs, such as sixteen. Each output has one, both or none of: an expression and an instruction. Optionally, operator confirmation is required. SCM step outputs also include notes, associated target, current, and entry values and monitoring task status, as well as optional and configurable delay after expression execution. SCM steps support a number of outputs and a step supports any combination of automatic control actions and instructions.

In this example, a table view 100 is provided for the operator. Table view 100 is composed of six major areas: an SCM summary area 102, a details area 104, an additional details area 106, a key parameters area 108, a trend area 110, and a buttons area 112. Table view 100 is implemented as an ActiveX Control in this example. An ActiveX Control is embeddable in any ActiveX document container, including HMIWeb™ displays. HMIWeb supports access to process graphic displays from a process control environment or a browser without requiring exports or fat plug-ins.

Table view 100 is driven from SCM summary area 102. A step selected in SCM summary area 102 determines what is shown in SCM summary area 102, details area 104, additional details area 106, key parameters area 108, and trend area 110. Next, the step/step output selection in second area 104 further determines what is shown in additional details area 106, and key parameters area 108. Operator changes made using table view 100 are recorded in an operator change journal.

SCM summary area 102 in table view 100 provides an SCM name 114, such as “CHD_H2_Sweep”. An alarm icon 116 appears when the SCM is in alarm. Under SCM name 114, is a list of steps 118 of the named SCM. The order of the steps in the list is not user-modifiable. An interaction required icon appears when instruction attention is needed by a step output of the step. This indication is not related to the step timeout alarm in any way. A condition icon appears when a transition condition with an error exists. An error icon appears when a step output with an error status exists. Tabs at the bottom of SCM summary area 102 allow selection of other handlers. A currently selected step is indicated by, for example, color or shading.

The steps in SCM summary area 102 are listed in an order of most likely execution based on an assumption that the left-most path at branching points is the most common path. Steps for all possible paths are shown, although only one path is selected when the SCM executes.

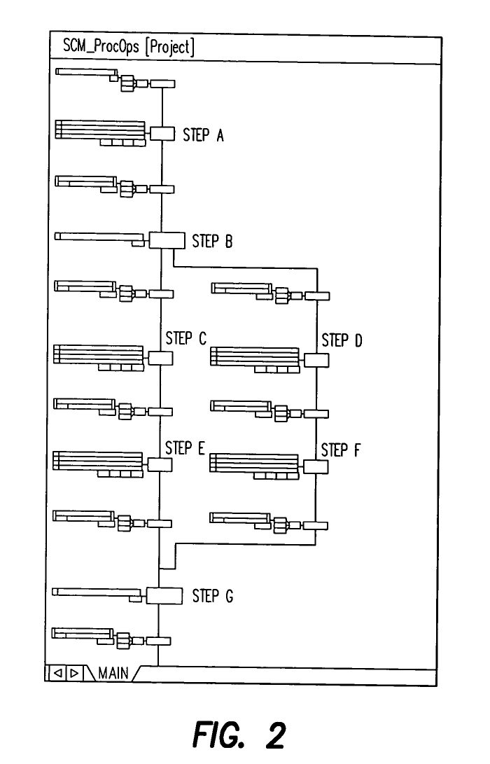

FIG. 2 shows a sequential function chart (SFC) view of an SCM configuration that has seven steps A-G. The two transitions after step B make a choice between one of two paths. In the example SCM shown in FIG. 2, SCM summary area 102 would list the steps in the following order {A, B, C, E, D, F, G}. In some embodiments, parallel execution paths and branch paths are shown.

Returning to FIG. 1, details area 104 in table view 100 provides details for a selected step in SCM summary area 102. Step description and the name of the step block are in the first row. Additional rows show output description. Outputs are expandable by clicking on a plus symbol. When expanded, an output's instruction is shown below the output description. After being expanded, clicking on a minus symbol collapses the output details. In some embodiments, there is an enabling option for whether the confirm box is displayed or not and options for sequential ordering. A confirm box appears if it is enabled, at least one confirmable instruction exists, and no sequential ordering options are selected.

Details area 104 sometimes includes a confirm checkbox. A confirm checkbox is shown in the first row for step level confirmation, if the step has at least one confirmable instruction and the step's enforce confirmable instruction order option is not selected. Clicking on the step confirm checkbox provides a 1-click operation that causes all individual confirmable instructions of the step to be confirmed. The confirm checkbox is conditionally shown in the confirm column for each step output row based on the step output configuration. A clickable checkbox indicates that a confirmable instruction exists in step output. An information indicator indicates that an informational instruction exists in step output. An expression indicator indicates that no instruction exists in step output but an expression does exist. The default of no indicator indicates that no instruction and no expression exist in step output.

Details area 104 includes a current column that shows a live, monitored value of a selected current parameter for step or step output. When the block that supplies the current parameter also supports an engineering units description parameter, the engineering units are also displayed. Details area 104 includes a task column to indicate the status of an associated monitoring task identified for the step or step output. An icon appears when the monitoring task result is on. Clicking the icon navigates to the detail display of the tag providing the monitoring task result. A color or shading indicates the step or step output currently selected in details area 104.

Additional details area 106 in table view 100 provides additional information for the selected step or step output in details area 104. The additional information includes warning, note, instruction, annotation, and expression in that order of priority. A series of tabs are provided in additional details area 106 and only tabs that have content are displayed. For example, if only a warning exists, then only the warning tab is shown in details area 106. Annotations allow an operator to enter comments during procedure execution which are journaled along with other SCM execution events.

Key parameters area 108 in table view 100 provides a number of key parameters for the selected step or step output in details area 104. For a step, a current parameter is shown, if the current parameter is configured. For a step output, the target, current, and entry parameters are shown, if the associated parameter references are configured.

Trend area 110 in table view 100 provides various graphs of trends. The values of current parameters from step and step outputs are optionally shown.

Buttons area 112 in table view 100 are made part of the other areas where needed. For example, SCM summary area 102 has tracking on/off and go to step buttons and details area 104 has expand and collapse buttons.

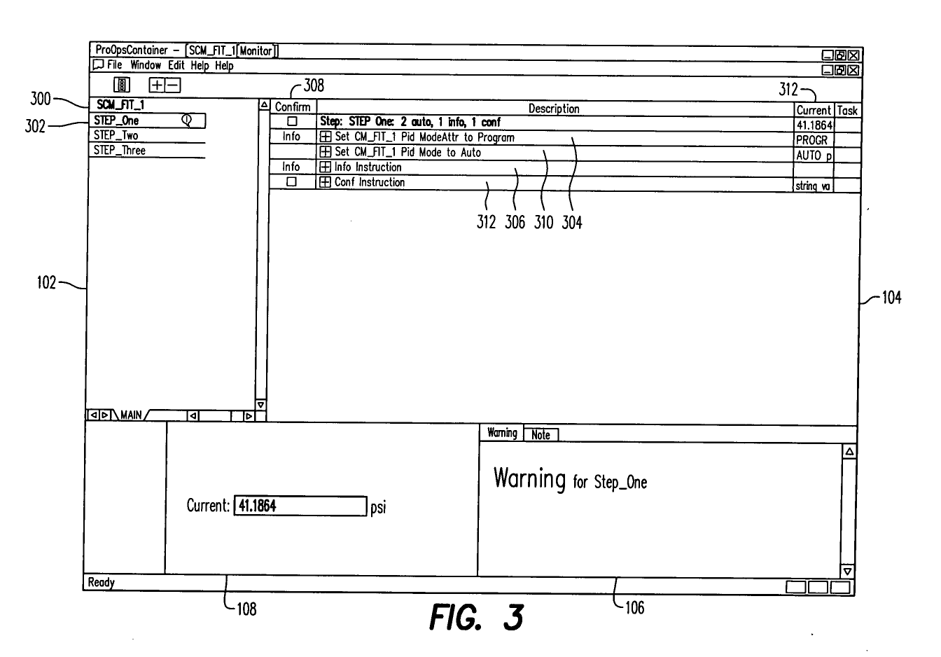

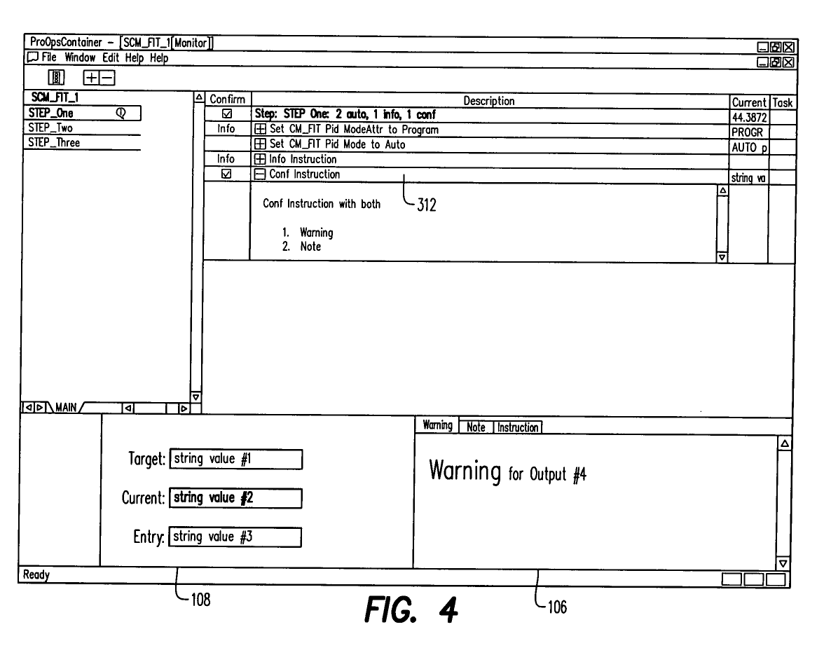

FIGS. 3-6 illustrate various features of table view 100 of the operator display shown in FIG. 1. FIG. 3 shows an example step having a confirmable instruction that is collapsed. In this example, an SCM named “SCM_FIT_{—}1” 300 with three steps is shown in SCM summary area 102. The active step 302, “STEP_One” is highlighted in green and has an interaction required icon indicating that interaction is required for this step. The outputs for “STEP_One” are listed in details area 104. The first output labeled “Set CM_FIT_{—}1 Pid ModeAttr to Program” 304 and the third output labeled “Info Instruction” 306 are information type instructions as indicated by the “info” label in the confirm column 308. The second output labeled “Set CM_FIT_{—}1 Pid Mode to Auto” 310 is an automatic expression. Current values are displayed for each instruction in the current column 312 and in key parameters area 108. A warning is shown for “STEP_One” in additional details area 106. When the operator clicks on the plus sign by the fourth output labeled “Conf. Instruction” 312, the step is expanded as shown in FIG. 4.

FIG. 4 shows an example step having the confirmable instruction that is expanded. With the fourth output labeled “Conf. Instruction” 312 selected, the target, current, and entry key parameters are shown in key parameter area 108 and a warning is shown in additional details area 106.

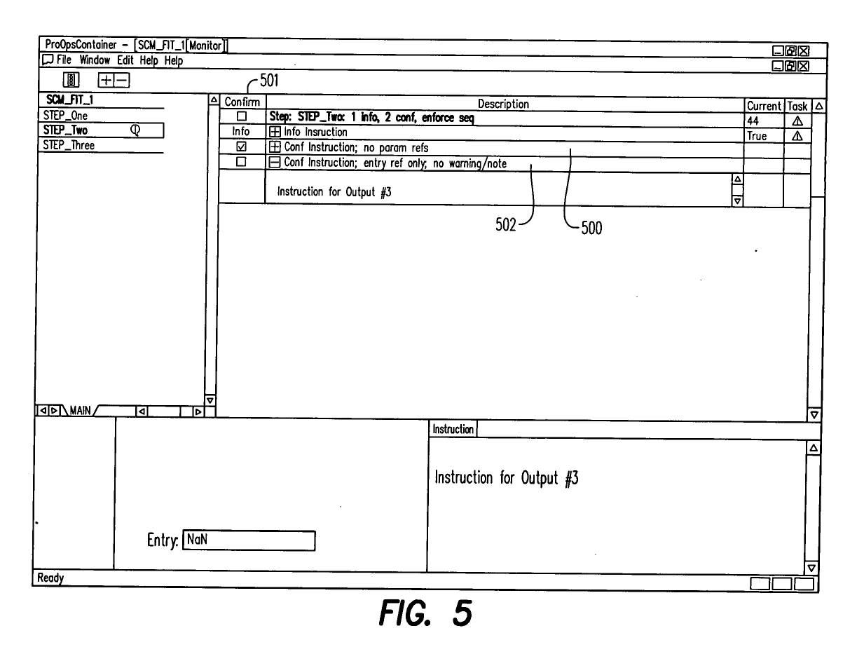

FIG. 5 shows an example step with one of two confirmable instructions confirmed. The second output labeled “Conf. Instruction; no param refs” 500 is confirmed as shown by the check mark in the confirm column 501, while the third output labeled “Conf Instruction; entry ref only; no warning/note” 502 is awaiting confirmation as shown by the box without a check mark in the confirm column 501.

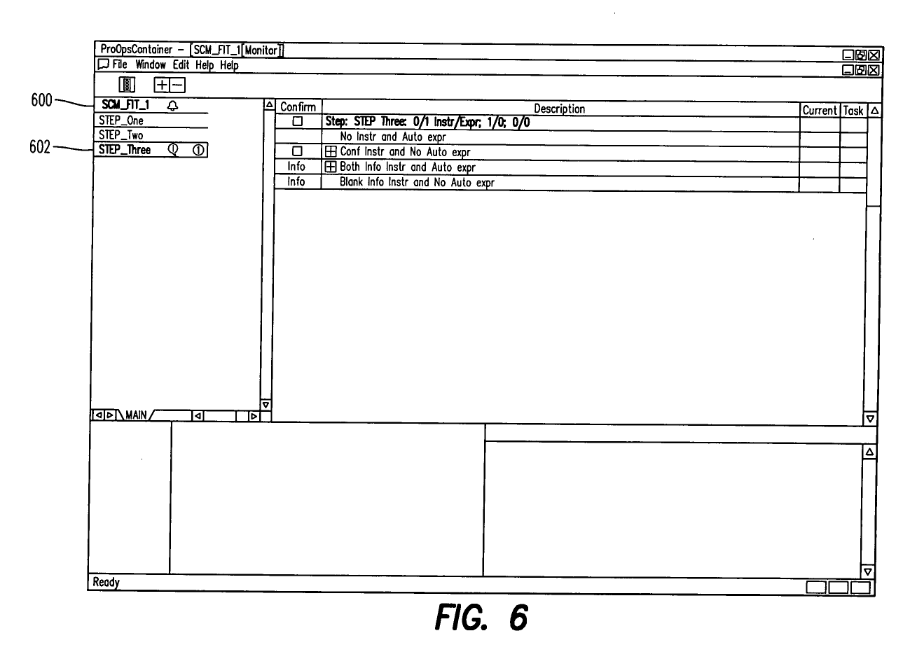

FIG. 6 shows an alarm and step output failure indication. A bell icon is shown next to the SCM named “SCM_FIT_{—}1” 600 and an error icon is shown next to the step named “STEP Three” indicating output failure and an interaction required icon indicates that instruction interaction is required for the step.

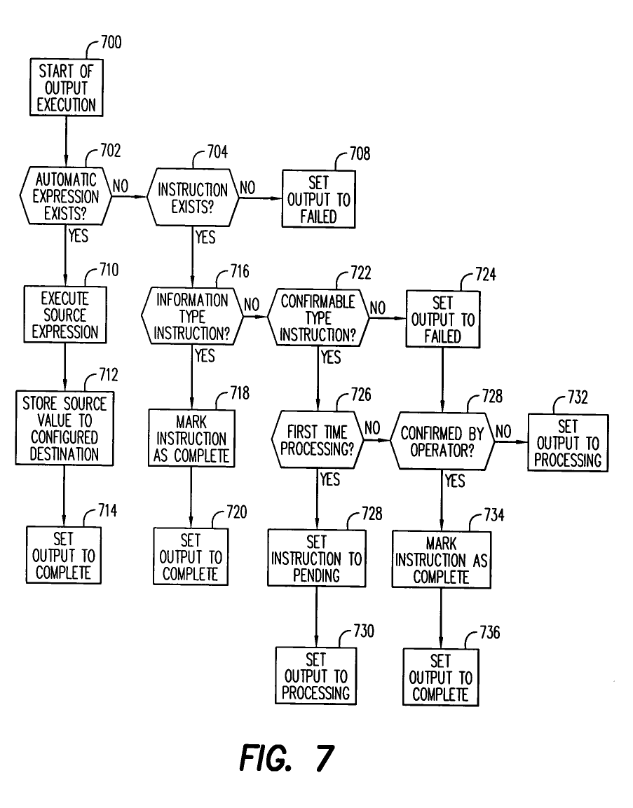

FIG. 7 shows an example method of step output execution supporting both automatic expressions and interactive instructions. Step 700 is the start of output execution. Step 702 determines whether an automatic expression exists. If not, control flows to step 704. In step 704, it is determined whether an instruction exists. If not, control flows to step 706, where the output is set to failure 708. If in step 702 an automatic expression does exist, control flows to step 710. In step 710, the source expression is executed and, then, in step 712 a source value to a configured destination is stored, and, in step 714, the output is set to complete. Destination of output store is any parameter in the same controller or a different controller. If, in step 704, an instruction exists, control flows to step 716, where it is determined whether the type of instruction is information. If so, the instruction is marked as complete in step 718 and, in step 720, the output is set to complete. If, in step 716, the type of instruction was not information, control flows to step 722. In step 722, it is determined whether the type of instruction is confirmable. If not, the output is set to failed, in step 724. Otherwise, if the instruction type is confirmable, control flows to step 726. In step 726, it is determined whether it is the first time processing. If so, the instruction is set to pending in step 728 and the output is set to processing in step 730. If, in step 726, it is not the first time processing, control flows to step 728. In step 728, it is determined whether the instruction is confirmed by the operator. If not, the output is set to processing in step 732. If so, the instruction is marked as complete in step 734 and the output is set to complete in step 736.

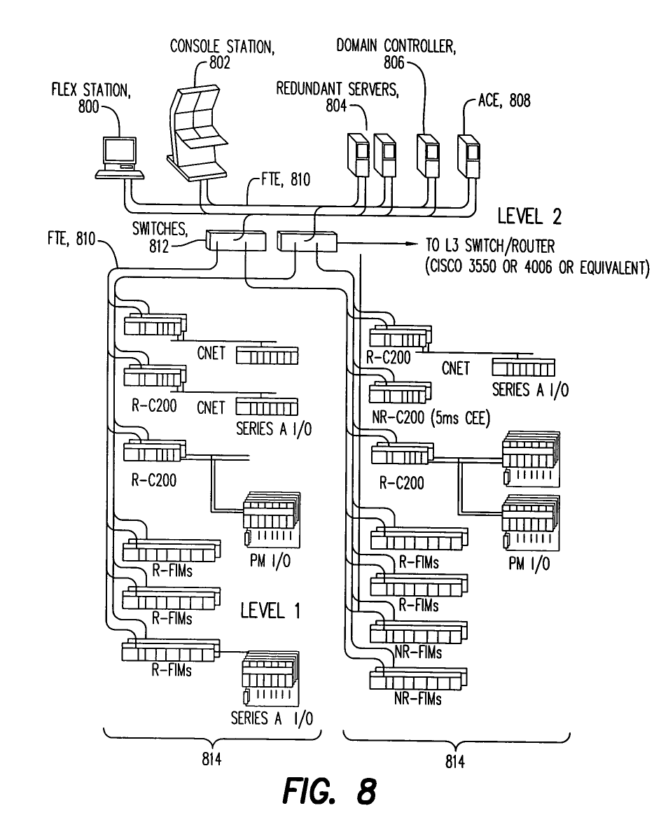

FIG. 8 shows an example system architecture. A flex station 800, console station 802, redundant servers 804, a domain controller 806, and an application control environment (ACE) 808 are shown on a fault tolerant Ethernet (FTE) 810. Flex station 800 and console station 802 have operator displays, such as those shown in FIGS. 1-6. ACE is a supervisory control platform for Experion PKS™ available from Honeywell International. FTE 810 and switches 812 are part of the Ethernet connectivity that results in connections to various process control systems 814 having various controllers and input/output (I/O) communications systems. Switches 812 help to provide fault tolerance where single cable breaks do not affect communications because alternate paths are available. Flex station 800 and console station 802 are used by an operator to execute interactive procedures for various process control systems 814.

The following scenarios illustrate some common operator interactions: configure and load interactive SCM, execute interactive SCM, abnormal execution where operator skips over steps, abnormal execution where there is a step timeout, SCM goes into held state, and user testing of interactive SCM.

In this scenario, an interactive SCM procedure is configured and loaded to an ACE. First, an SCM is created. Steps and transitions are created and interconnected to form the procedure structure. Second, using the SFC view and the step transition configuration forms, details of the steps and transitions are entered. Finally, the SCM is assigned to the intended ACE and then loaded to the ACE.

In this scenario, an operator starts and executes an interactive SCM procedure. First, at a station, the operator selects the procedure to be executed, which calls up table view 100. Next, using a command button, the operator issues a start command to the SCM. The first step of the main handler is automatically selected in SCM summary area 102 and the step output descriptors are shown in details area 104. Next, outputs of the step are expanded one-by-one to see the instruction. After completing each action, the operator confirms each instruction by clicking a checkbox to the left of the instruction. After the last output is completed, SCM summary area 102 advances the selection to the next step and the step output descriptors for the next step are shown in details area 104 of the display. The step outputs are shown collapsed and are expandable by the operator. If a warning exists for the next step, it is shown in additional details area 106. The outputs of the step are expanded until the last step is finished. On completion of the last step, the SCM changes from running to complete. Finally, using the command button, the operator issues a reset command to the SCM to prepare the SCM for another execution.

In this scenario, an operator starts execution of a different step. The operator selects step in the SCM summary area 102. Tracking is automatically turned off when a step is selected to prevent the newly selected step from changing unexpectedly. To turn tracking on again, the user clicks on the tracking icon. The behavior of a step selection causing tracking to be automatically turned off occurs on step selections in the SCM summary area 102. The operator clicks on the right arrow button to initiate the execution of the selected step. A dialog box is shown for the operator to confirm the intended operation. An option is provided on the confirmation dialog for whether to stay in single step mode or return to the previous mode before the action was initiated. After confirming the requested action, the following occur automatically: SCM mode is changed to single step, SCM target step is changed to the selected step, SCM command of resume is provided to initiate execution of the new step, and optionally return SCM mode to its previous mode.

In this scenario, an SCM step timeout alarm occurs and the operator needs to investigate. After completion of a step, the operator waits for the next step to become active and its details to appear in details area 104. When the next step does not become active within the a configured maximum time for the previous step, two indicators appear on the display: a “C” in SCM summary area 102 next to the currently active step and an alarm indicator in SCM summary area 102 because of the step timeout alarm. Next, these indicators prompt the operator to start investigating what is wrong. The operator switches from table view 100 to SFC view. The SFC view shows the active step and the subsequent transition at which the SCM is stuck. From analyzing the transition conditions that are not yet true, the operator determines the problem and takes the appropriate action. Perhaps a condition is false because of a bad transmitter. If so, the operator overrides the condition and sets it to true, switches back to the table view 100, and continues the SCM execution.

In this scenario, an SCM automatically changes state from running to held because of the current process conditions. While in the midst of working on a set of step output instructions for a step, SCM summary area 102 changes to show the enabled hold handler and details area 104 also changes. The outputs and instructions of the previously active step that were displayed in details area 104 are no longer visible. Once in the held state, the operator has a choice to restart the procedure execution or to stop or abort the procedure.

In this scenario, a method of testing an SCM procedure is illustrated. A control engineer configures any strategies needed for simulating an actual process I/O. The SCM procedure to be tested, e.g., SCM123, is copied and the copy, e.g. SCM123_sim, is updated to use the I/O simulation strategies as needed. Both the simulation SCM, SCM123_sim, and the I/O simulation strategies are loaded to ACE. Using appropriate HMIWeb custom displays and table view 100, the operator executes the SCM123_sim procedure. Anomalies are recorded throughout the test. After fixes are implemented, testing is repeated as needed.

In an example embodiment, an SCM step output feature is configurable with instruction and instruction type fields. The instruction is a formatted text string that is used to provide instructions to an operator during the execution of the SCM. The instruction type selects what form of operator response to the instruction is required at execution time. Examples of instruction type are information (no operator response needed) and confirm (operator confirmation is needed). In this way, step output is capable of either an automatic control action or an instruction to the operator. Optionally, the system can provide that the steps must be confirmed or completed in a particular order.

In the example embodiment, the SCM step output feature is configurable with note information that is viewable by the operator at the time of SCM execution. This provides additional information that is accessible by the operator on a per step output basis.

In the example embodiment, the SCM step output feature has the following associated parameters: target value, current value, entry value, and monitoring task status. The target value shows the desired value of a key measurement and is configurable to determine whether its value is changeable at run-time. The current value shows the current value of a key measurement on the operator display 100. The current value is configurable as to whether is it included in the trend area 110. The entry value allows for operator entry of an actual value of a key measurement on the operator display 100. The monitoring task status is a Boolean result of a monitoring task logic component and an indication is shown on the operator display 100 when the value is on. The parameters are visible on a per step output basis.

In the example embodiment, the SCM step note and warning features are supported. They are viewable by the operator at the time of SCM execution. This provides additional information that is accessible by the operator on a per step basis.

In the example embodiment, the SCM step feature supports the following associated parameters: current value and monitoring task status. This allows one key process value to be visible to the operator per step.

In the example embodiment, there is an SFC view for viewing step output instruction and instruction type fields. In this way, there is a continued ability to see key step output configuration data from the SFC view. The SFC view is used for editing the SCM configuration.

In the example embodiment, there is table view 100 that provides a more condensed view of the SCM than the SFC view. There is also an option for toggling between the SFC and SCM views. Table view 100 is expandable and collapsible to show (from least to most detail): step summary information, step outputs summary information, step outputs instruction information, and step outputs expression information. Step summary information and step outputs summary information include description and associated parameter reference (for current value). Step outputs instruction information includes instruction, instruction type, and associated parameter references (for target, current, and entry values). Step outputs expression information includes expression and expression type. Expanding and collapsing is available at least for the entire view, per step, and per output. Indicators for branching points and straight-line groups of steps are shown. Filter selection is provided to choose what is shown in table view 100, including most common branch path, steps that have been executed, all steps, and all transitions. There is an ability to show or hide the step name at the end of the step description. The step configuration form is accessible from the step or step output.

In the example embodiment, SCM execution features include: SCM step output confirmation, SCM step output instruction status, SCM step instruction confirmation, SCM step instruction status, SCM instruction status, SCM active location instruction status, operator change journal, and SCM automatic or interactive option.

In the example embodiment, the SCM step output supports a parameter that is stored to confirm that an instruction has been completed. This enables check-off feedback from the operator to the executing SCM function block (FB). Information type instructions are not confirmed. The operator is prompted to confirm the confirmation in the same way that all parameter stores are confirmed. Once all step outputs are checked-off, the summary confirmation for the step is automatically checked. Once confirmed, the instruction cannot be unconfirmed.

In the example embodiment, the SCM step output instruction status feature includes parameters for indicating both whether the instruction includes interaction and whether the instruction is complete.

In the example embodiment, the SCM instruction confirmation feature includes a parameter that is stored to confirm all individual confirmable type instructions of a step. This single action saves the operator from having to confirm or check-off individual instructions one-by-one. Step confirmation is journaled as a step confirmation. When the entire step is confirmed in one action, individual step output confirmation are seen in the operator change journal.

In the example embodiment, the SCM step instruction status feature includes parameters that reflect the composite status for all step outputs for indicating both whether an output instruction needs interaction and whether all output instructions are complete.

In the example embodiment, the SCM instruction status feature includes parameters that reflect the composite status for all of steps for indicating whether a step output instruction requires interaction.

In the example embodiment, the SCM active location instruction status feature includes parameters that reflect the composite status of the active step for all active step outputs for indicating both whether an output instruction needs interaction and whether all output instructions are complete.

In the example embodiment, the operator change journal feature records all operator interactions with the SCM system. Operator step and step output confirmations and entry of values are recorded for later analysis and report generation.

In the example embodiment, the SCM automatic or interaction option provides a choice between automatic and interactive execution. When an SCM step output has both an instruction and expression configured, this option determines which one is executed. This enables an SCM to be configured for both automatic and interactive execution and a run-time choice is made for which way to execute the SCM. There is a default of automatic.

In the example embodiment, SCM operation includes the following features: monitoring of associated parameters, monitoring tab table view 100, an embeddable monitor tab table view 100, and a dashboard for navigation.

In the example embodiment, monitoring of associated parameters is performed from the SCM table chart view where run-time values of currently selected step and step output associated parameters are shown.

In the example embodiment, monitoring tab table view 100 includes providing a monitor tab table chart view. Step and step outputs provide an indication when confirmation is needed other than the confirmation parameter being shown. A special symbol, color, or the like are possible indications. The user selects which columns, the order of columns, and the column widths of the information in table view 100. An indication is shown that allows the operator to determine that the manual instructions are complete. Step and transition errors are also indicated. An indication is shown when the SCM is in alarm. Display call-up uses a centered approach that is centered around the active step. One previously executed step, the active step, and at least one next step are shown. Scaling is allowed so that a process graphic allows the user to observe the progress of an SCM. A trend display is integrated into table view 100. Parameters shown on the trend are the selected current values from the step and step outputs. The content changes when a new step becomes active. The time base is the step start time.

In the example embodiment, the SCM monitor tab table chart view is embeddable in any ActiveX document container, e.g., a station detail display or an HMIWeb custom display.

It is to be understood that the above description is intended to be illustrative and not restrictive. Many other embodiments will be apparent to those of skill in the art upon reviewing the above description, such as adaptations of the present disclosure to process automation systems in various industries. Various designs using hardware, software, and firmware are contemplated by the present disclosure, even though some minor elements would need to change to better support the environments common to such systems and methods. The present disclosure has applicability to fields outside industry, such as academic, government and other kinds of fields. Therefore, the scope of the present disclosure should be determined with reference to the appended claims, along with the full scope of equivalents to which such claims are entitled.

1. A method of providing interactive instructions in sequential control modules, comprising:
determining whether a current instruction in an output in a sequential control module is a confirmable type;
determining whether said current instruction is confirmed by an operator, if said current instruction is said confirmable type; and
marking said current output as complete, if said current instruction is confirmed by said operator and said current instruction is said confirmable type.

2. The method according to claim 1, further comprising:
determining whether said current instruction is an information type; and
marking said current output as complete, if said current instruction is said information type.

3. The method according to claim 1, further comprising:
determining whether said current output is an automatic type;
executing an expression in said output, if said current output is said automatic type; and
storing a value of said expression to a destination reference, if said current output is said automatic type.

4. A system for providing interactive instructions in sequential control modules, comprising:
a user interface component to provide a table view;
an operator station capable of executing said user interface component; and
at least one controller which is operated by executing at least one interactive instruction or non-interactive instruction from said table view, said interactive or non-interaction instruction being part of a sequential control module.

5. The system according to claim 4, further comprising:
a journaling component capable of being executing on said operator station for recording information related to the execution of said sequential control module.

6. The system according to claim 4, wherein said table view comprises:
a summary area for providing a name of said sequential control module and a list of steps in said sequential control module;
a details area for providing a step name and a step description for a selected step in said list of steps; and
a parameters area for providing a current value of at least one parameter associated with said selected step.

7. The system according to claim 6, wherein said table view further comprises:
an additional details area for information associated with said selected step.

8. The system according to claim 6, wherein said table view further comprises:
a trend area for providing a graph of said at least one parameter associated with said selected step.

9. The system according to claim 6, wherein said details area includes a confirmation component to receive a confirmation from an operator.

10. The system according to claim 4, wherein said user interface component also provides a sequential function chart view.

11. A computer readable medium having executable instructions stored thereon to perform a method of providing interactive instructions in sequential control modules, said method comprising:
providing a type indication on a display for an instruction in a sequential control module, said type being confirmable or informational; and
receiving a confirmation from an operator before completing said instruction, if said type is confirmable.

12. The computer readable medium according to claim 11, further comprising:
providing at least one value of a parameter associated with said instruction on said display.

13. The computer readable medium according to claim 11, further comprising:
providing additional information about said current instruction on said display.
